(19) United States
(12) Patent Application Publication
(10) Pub. No.: US 2026/0009989 A1
(43) Pub. Date: Jan. 8, 2026

(54) FLUORESCENCE MICROSCOPE ILLUMINATION METHOD AND FLUORESCENCE ASSEMBLY UTILIZING PULSED XENON LAMP

(71) Applicant: SUZHOU FENGTAI MEDICAL TECHNOLOGY CO., LTD., Suzhou, Jiangsu (CN)

(72) Inventors: Yuefeng Yin, Suzhou, Jiangsu (CN); Lan Fu, Suzhou, Jiangsu (CN); Xue Zhong, Suzhou, Jiangsu (CN)

(21) Appl. No.: 19/136,264

(22) PCT Filed: Feb. 13, 2025
(86) PCT No.: PCT/CN2025/077104

§ 371 Date: Jun. 5, 2025

(30) Foreign Application Priority Data
Jun. 19, 2024 (CN) 202410788595.5

(51) Int. Cl. G02B 21/00

(52) U.S. Cl. CPC G02B 21/0064; G02B 21/0032; G02B 21/0076

(57) ABSTRACT

A fluorescence microscope illumination method and a fluorescence assembly utilizing pulsed xenon lamp, wherein the fluorescence assembly comprises a wheel disc component, a camera component, and a light source component. The wheel disc component comprises a wheel disc mounting plate, on which a plurality of triple-hole fluorescent filter boxes are provided through a central shaft and a mounting shaft; a through hole is provided on the wheel mounting plate, and the mounting shaft is driven to rotate at a fixed angle, so that the boxes can stay in turn just below the through hole; the second stepper motor drives the side wheel disc to rotate at a fixed angle, so that the light source filter holes can stay in turn just in front of the lens. The invention can provide a microsecond-level high-brightness light source, greatly improve the photographing rate without reducing the image quality.

### TECHNICAL FIELD

The invention relates to the technical field of fluorescence microscopes, and in particular to a fluorescence microscope illumination method and a fluorescence assembly utilizing pulsed xenon lamp.

### BACKGROUND ART

Fluorescence microscopy can be used to image biological samples in a variety of ways, such as two-dimensional, three-dimensional, and time series. Fluorescence microscopy can observe the specific structures and physiological functions of microscopic biological systems such as living cells, animals, and bacteria in real time. Therefore, fluorescence microscopy has been widely used in biomedicine, medical diagnosis, and drug development.

### (I) Application in Biomedicine

1. Research on biological macromolecules: fluorescent labeling can track and record the changes in molecules in real time, so fluorescence microscopy imaging technology is widely used in the study of protein, cell membrane, DNA and RNA structure; 2. cell biology: fluorescence microscopy imaging technology can perform real-time imaging of physiological processes at the molecular level in cells, such as organelles, cell membranes, gene expression, cell cycle, etc., and can reveal the occurrence, development and termination of basic physiological processes of cells from both spatial and temporal dimensions, including cell migration, proliferation and apoptosis; 3. neuroscience: fluorescence microscopy imaging technology can observe the changes in microscopic structures such as nerve cells, nerve fibers and synapses in real time, including the morphology and distribution of synapses, nerve discharges and nerve images.

### (II) Application in Medical Diagnosis

1. Bio-labeling technology: fluorescent dyes are labeled on biomarkers to be detected, such as viruses, cells, proteins, tumors, etc., which can be used for the detection and pathological diagnosis of various diseases; 2. tissue sections: fluorescence microscopes can efficiently image tissue sections to help medical scientists conduct more detailed research and diagnosis of diseases.

### (III) Application in Drug Development

1. Analysis and screening of drugs: fluorescence microscopes can help scientists quickly screen new drugs and determine their efficacy from the molecular to the cellular level; fluorescent labels can be used to analyze the transport and metabolism of drugs, providing assistance in exploring the mechanism of drug action; 2. toxicology research: fluorescence microscopes can perform efficient three-dimensional imaging of biological molecules, cells, tissues, and mouse models to study the toxicity and side effects of chemical substances.

Most current fluorescence microscopy technologies use high-pressure mercury lamps as the illumination source. Monochromatic light is obtained through the light source filter and the sample is illuminated using the epi-illumination method. The sample fluorescence is obtained through the fluorescence filter and then entered into the camera to take pictures to obtain the sample fluorescence information. However, the high-pressure mercury lamp used in current fluorescence microscopes is a continuous light source. Therefore, when the sample fluorescence is weak, the camera requires a longer exposure time (100 ms or longer), but the corresponding shooting rate cannot be increased, and this results in the inability of existing fluorescence microscopy technology to achieve high-speed image scanning and rapid output of large sample quantities.

### SUMMARY OF THE INVENTION

In view of the defects of the prior art, the invention provides a fluorescence microscope illumination method and a fluorescence assembly utilizing pulsed xenon lamp, which can provide a microsecond-level high-brightness light source and greatly improve the shooting rate without reducing the image quality.

In order to solve the above technical problems and achieve the above technical effects, the invention is implemented through the following technical solutions.

A fluorescence microscope illumination method utilizing pulsed xenon lamp, wherein a high-frequency pulsed xenon lamp is used as a light source to provide high-frequency pulsed illumination through epi-illumination to a sample on a slide, including the following steps:
step 1) generating lateral pulsed light beams using the high-frequency pulsed xenon lamp;
step 2) filtering the pulsed light beams through a light source filter;
step 3) reflecting the filtered pulsed light beams downward via a reflector;
step 4) directing the downward-reflected pulsed light beams onto the slide through an objective lens, wherein a part of the pulsed light beams is reflected upward upon contacting the sample;
step 5) directing the upward-reflected pulsed light beams sequentially through the objective lens, the reflector, and a fluorescence filter before entering a camera.

An electron microscope fluorescence assembly utilizing pulsed xenon lamp, comprising a wheel disc component, a camera component, and a light source component, wherein:
the wheel disc component comprises a horizontal wheel disc mounting plate, a lower surface of which is provided with a central shaft extending vertically downward, a mounting shaft driven by a wheel disc driving mechanism is rotatably sleeved on the central shaft, and the mounting shaft is provided with multiple triple-hole fluorescence filter boxes uniformly distributed around its circumference; a through hole is provided on the wheel disc mounting plate, and a detection position is located directly below the through hole; the wheel disc driving mechanism drives the mounting shaft to rotate at a fixed angle, thereby enabling all the triple-hole fluorescent filter boxes to stay in the detection position in turn; the camera component is located directly above the through hole, and the camera component, the through hole and the triple-hole fluorescent filter box located at the detection position are vertically coaxial;
the light source component is located outside the detection position, and comprises a high-frequency pulsed xenon lamp, a lens, and a side wheel disc driven by a second stepper motor; the lens is located directly in front of the high-frequency pulsed xenon lamp, and the position directly in front of the lens is a light-transmitting position; the side wheel disc is located in front of the lens and is provided with multiple light source filter holes uniformly distributed around its circumference, each covered with a light source filter; the second stepper motor drives the side wheel disk to rotate at a fixed angle, thereby enabling all the light source filter holes to stay in the light-transmitting position in turn; the high-frequency pulsed xenon lamp, the lens, the light source filter hole located at the light-transmitting position, and the triple-hole fluorescent filter box located at the detection position are transversely coaxial.

Further, the wheel disc driving mechanism is composed of a first stepper motor, a first spur gear, a second spur gear, and an angle sensor; the first stepper motor is vertically mounted on the wheel disc mounting plate, and both are located on one side of the central shaft and the camera component; the first spur gear is fixedly mounted on an output shaft of the first stepper motor, and the second spur gear is sleeved on a periphery of the central shaft and fixedly connected to an upper end surface of the mounting shaft; the first spur gear and the second spur gear are at the same height position and mesh with each other; the angle sensor comprises a magnetic encoder, a central magnet, a magnet seat, and a socket; the magnetic encoder is fixed on an axis of a lower end surface of the central shaft, and the magnet seat is fixedly connected to a lower end surface of the mounting shaft; the central magnet is fixed inside the magnet seat and is located directly below the magnetic encoder; a cable of the magnetic encoder passes upward through a hollow inner cavity of the central shaft and is connected to the socket; the first stepper motor measures the angular displacement of the angle sensor, thereby achieving a fixed angle rotation of the mounting shaft and the alternating docking of all the triple-hole fluorescent filter boxes with a lower end of the through hole.

Further, the wheel disc component is provided with a first mechanical angle-limiting mechanism, which comprises a first flat spring, a first micro bearing seat, a first micro pin, a first roller, a plurality of first roller positioning counterbores and a plurality of first roller rolling grooves circumferentially provided on the second spur gear; an inner end of the first flat spring is fixedly connected to an upper end surface of the central shaft, and an outer end of the first flat spring points in a direction of the detection position; the first micro bearing seat is fixed on a lower surface of the outer end of the first flat spring, and the first roller is mounted on the first micro bearing seat through the first micro pin; the number of the first roller positioning counterbores and the first roller rolling grooves corresponds to the number of the triple-hole fluorescent filter boxes, and the opening position of the first roller positioning counterbores corresponds to the position of the triple-hole fluorescent filter boxes; the opening position of the first roller rolling groove is located between two adjacent first roller positioning counterbores; an upper plane of the first roller positioning counterbores is higher than an upper plane of the first roller rolling groove to provide damping and a clamping point for the first roller.

Further, the triple-hole fluorescent filter box comprises a cubic box body, and a top surface thereof is provided with an upper beam passage hole for docking with a lower end of the through hole, covered with a fluorescent filter; a lower beam passage hole for docking with an upper end of the objective lens is provided on a bottom surface of the cubic box body, and the upper beam passage hole is concentric with the lower beam passage hole; a side beam passage hole for docking with an inner end of the light source filter hole is provided on one side surface of the cubic box body; an inclined reflector is provided inside the cubic box body, and the light source component provides epi-illumination to the slide located below the objective lens through the reflector.

Further, the mounting shaft is provided with vertical dovetail protrusions uniformly distributed around its circumference, and the number of the dovetail protrusions corresponds to the number of the triple-hole fluorescent filter boxes; a dovetail groove capable of plugging and matching with the dovetail protrusion is provided on one side surface of each triple-hole fluorescent filter box, and the position of the dovetail groove is opposite to the position of the side beam passage hole; a limiting plate is provided on an outer periphery of an upper end of the mounting shaft, and the limiting plate is fixedly connected to upper end surfaces of all the dovetail protrusions; the triple-hole fluorescent filter box is quickly mounted with the mounting shaft through the matching of the dovetail groove and the dovetail protrusion, and positioning is achieved through the limiting plate; a C-shaped mounting groove is provided on a surface of each dovetail protrusion; a notch of the C-shaped mounting groove extends to a side edge of the dovetail protrusion, and an oblique pressure block is provided in the C-shaped mounting groove which can protrude outward or retract inward relative to an outer wall of the mounting shaft; an edge of the oblique pressure block is located at the notch of the C-shaped mounting groove and is flush with the edge of the dovetail protrusion, and the dovetail groove is locked or unlocked with the dovetail protrusion by the retraction or protrusion of the oblique pressure block.

Further, the camera component is composed of a camera body, a reducing lens and a lens barrel; a lower end of the lens barrel is fixedly connected to a groove provided around an upper end of the through hole, and an upper end of the lens barrel is connected to the lens of the camera body through the reducing lens.

Further, the light source component comprises a horizontal light source mounting plate with a lamp holder seat provided below through a lamp holder fixing seat, and the high-frequency pulsed xenon lamp is fixedly mounted in the lamp holder seat; a C-shaped seat extending forward is provided at a bottom end of the lamp holder fixing seat; the lens is fixedly mounted on a middle part of the C-shaped seat through a lens fixing piece, and a side wheel disc connecting plate is provided at a front part of the C-shaped seat; a connecting strip extending to one side is provided on a top of the side wheel disc connecting plate, and the second stepper motor is fixedly mounted on a lower surface of the connecting strip through a motor mounting plate; a center of an outer side surface of the side wheel disc is fixedly connected to an output shaft of the second stepper motor through a connecting piece.

Further, the light source component comprises a horizontal light source mounting plate with a lamp holder seat provided below through a lamp holder fixing seat, and the high-frequency pulsed xenon lamp is fixedly mounted in the lamp holder seat; a C-shaped seat extending forward is provided at a bottom end of the lamp holder fixing seat; the lens is fixedly mounted on a middle part of the C-shaped seat through a lens fixing piece, and a side wheel disc connecting plate is provided at a front part of the C-shaped seat; a connecting strip extending to one side is provided on a top of the side wheel disc connecting plate, and the second stepper motor is fixedly mounted on a lower surface of the connecting strip through a motor mounting plate; a center of an outer side surface of the side wheel disc is fixedly connected to an output shaft of the second stepper motor through a connecting piece.

Further, the light source component comprises a horizontal light source mounting plate with a lamp holder seat provided below through a lamp holder fixing seat, and the high-frequency pulsed xenon lamp is fixedly mounted in the lamp holder seat; a C-shaped seat extending forward is provided at a bottom end of the lamp holder fixing seat; the lens is fixedly mounted on a middle part of the C-shaped seat through a lens fixing piece, and a side wheel disc connecting plate is provided at a front part of the C-shaped seat; a connecting strip extending to one side is provided on a top of the side wheel disc connecting plate, and the second stepper motor is fixedly mounted on a lower surface of the connecting strip through a motor mounting plate; a center of an outer side surface of the side wheel disc is fixedly connected to an output shaft of the second stepper motor through a connecting piece. the number of the second roller positioning counterbores and the second roller rolling grooves corresponds to the number of the light source filter holes, and the opening position of the second roller positioning counterbores correspond to the position of the light source filter holes; the opening position of the second roller rolling grooves are located between two adjacent second roller positioning counterbores; an upper plane of the second roller positioning counterbores is higher than an upper plane of the second roller rolling grooves to provide damping and a clamping point for the second roller.

Further, the high-frequency pulsed xenon lamp emits pulsed light at 160-7500 nm wavelengths with a maximum frequency of 200 Hz.

The beneficial effects of the invention are as follows.
1. The invention replaces the light source of the fluorescence microscope with a pulsed xenon lamp and adopts an epi-illumination method, thereby providing a microsecond-level high-brightness light source. Without reducing the image quality, the shooting rate (200 frames/second) is greatly improved, which is more than 20 times that of the existing technology, and the preheating time is short, the stability is good, and high-speed fluorescence microscope scanning can be achieved.
2. The pulsed xenon lamp used in the invention adopts a pulsed working mode, so the service life is longer than that of a continuous light source, and the corresponding cost is lower.
3. The invention adopts dual positioning of angle sensor and mechanical limit, so that the rotation angle of the fluorescence filter and the light source filter is more accurate and can be kept stable.

The fluorescence filter box of the invention is assembled with the mounting shaft by dovetail groove plug-in, and is fixed with an oblique pressure block, which greatly facilitates the disassembly and assembly of the fluorescence filter box, and can also ensure the reliability of the mounting.

The above description is only an overview of the technical solution of the invention. In order to more clearly understand the technical means of the invention and implement it according to the content of the specification, the following is a detailed description of the preferred embodiment of the invention with reference to the drawings. The specific implementation of the invention is given in detail by the following embodiments and drawings.

### BRIEF DESCRIPTION OF THE DRAWINGS

The drawings described herein are used to provide a further understanding of the invention and constitute a part of this application. The exemplary embodiments of the invention and their descriptions are used to explain the invention and do not constitute an improper limitation of the invention.

FIG. 1 is a front-view stereoscopic diagram of the invention;

FIG. 2 is a rear-view stereoscopic diagram of the invention;

FIG. 3 is a bottom-view stereoscopic diagram of the invention;

FIG. 4 is a stereoscopic diagram of the wheel disc component in the invention;

FIG. 5 is a stereoscopic diagram of the wheel disc component in the invention after the wheel disc mounting plate is removed;

FIG. 6 is a schematic diagram of the assembly relationship between the triple-hole fluorescent filter box and the mounting shaft in the wheel disc component of the invention;

FIG. 7 is an exploded view of the central shaft, the mounting shaft and the angle sensor in the wheel disc component of the invention;

FIG. 8 is a front perspective view of the triple-hole fluorescent filter box in the wheel disc component of the invention;

FIG. 9 is another front perspective view of the triple-hole fluorescent filter box in the wheel disc component of the invention;

FIG. 10 is a schematic diagram of the assembly relationship between the oblique pressure block and the mounting shaft in the wheel disc component of the invention;

FIG. 11 is a structural diagram of the first mechanical angle-limiting mechanism in the wheel disc component of the invention;

FIG. 12 is a stereoscopic diagram of the camera component in the invention;

FIG. 13 is a rear-view stereoscopic diagram of the light source component in the invention;

FIG. 14 is a front-view stereoscopic diagram of the light source component in the invention;

FIG. 15 is a schematic diagram of the mounting position of the water-cooling cooler in the light source component of the invention;

FIG. 16 is a structural diagram of the second mechanical angle-limiting mechanism in the light source component of the invention;

FIG. 17 is a diagram showing the working principle of the invention.

### SPECIFIC EMBODIMENT OF THE INVENTION

The following describes preferred embodiments of the invention with reference to the drawings to clarify the objectives, features, and advantages of the invention. It shall be understood that the embodiments illustrated in the drawings do not limit the scope of the invention but are provided to elucidate the essence of the technical solutions.

In the following description, specific details are set forth for the purpose of explaining various disclosed embodiments to facilitate a thorough understanding. However, those skilled in the relevant art will recognize that the embodiments may be practiced without one or more of these specific details. In other instances, well-known devices, structures, and techniques associated with this application have not been shown or described in detail to avoid unnecessarily obscuring the description.

Unless the context clearly requires otherwise, throughout the specification and claims: the terms “comprise,” “comprising,” and variations such as “include” or “having” shall be construed in an open, inclusive sense, i.e., “including but not limited to.”

References to “one embodiment” or “an embodiment” mean that a particular feature, structure, or characteristic described in connection with the embodiment is included in at least one embodiment. Thus, occurrences of the phrases “in one embodiment” or “in an embodiment” in various places throughout the specification are not necessarily all referring to the same embodiment. Furthermore, the particular features, structures, or characteristics may be combined in any manner in one or more embodiments.

As used in this specification and the appended claims, the singular forms “a,” “an,” and “the” include plural referents unless the context clearly dictates otherwise. It should be noted that the term “or” is generally employed in its sense including “and/or” unless the context clearly dictates otherwise.

Furthermore, technical features involved in different implementations of the invention described hereinafter may be combined in any manner provided that they do not conflict with each other.

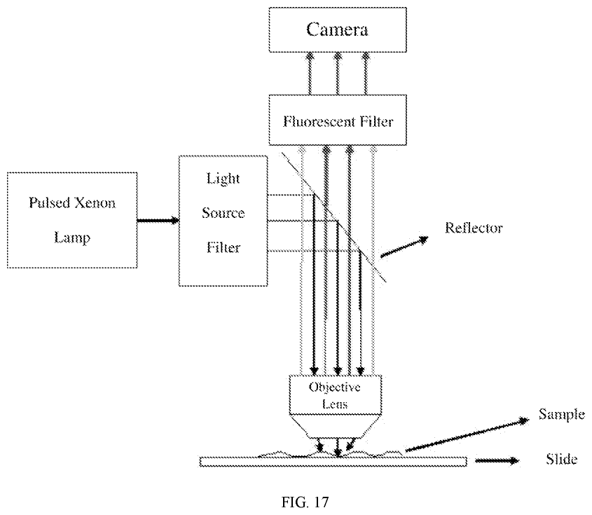

With reference to FIG. 17, a fluorescence microscope illumination method utilizing pulsed xenon lamp, wherein a high-frequency pulsed xenon lamp is used as a light source to provide high-frequency pulsed illumination through epi-illumination to a sample on a slide, including the following steps:
step 1) generating lateral pulsed light beams using the high-frequency pulsed xenon lamp;
step 2) filtering the pulsed light beams through a light source filter;
step 3) reflecting the filtered pulsed light beams downward via a reflector;
step 4) directing the downward-reflected pulsed light beams onto the slide through an objective lens, wherein a part of the pulsed light beams is reflected upward upon contacting the sample;
step 5) directing the upward-reflected pulsed light beams sequentially through the objective lens, the reflector, and a fluorescence filter before entering a camera.

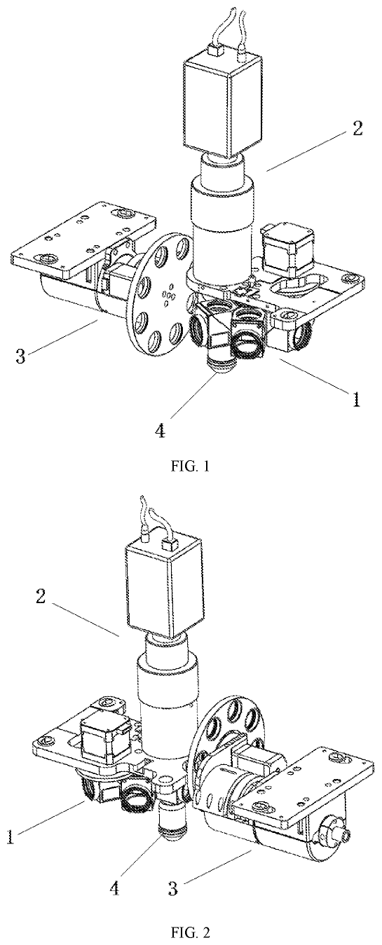

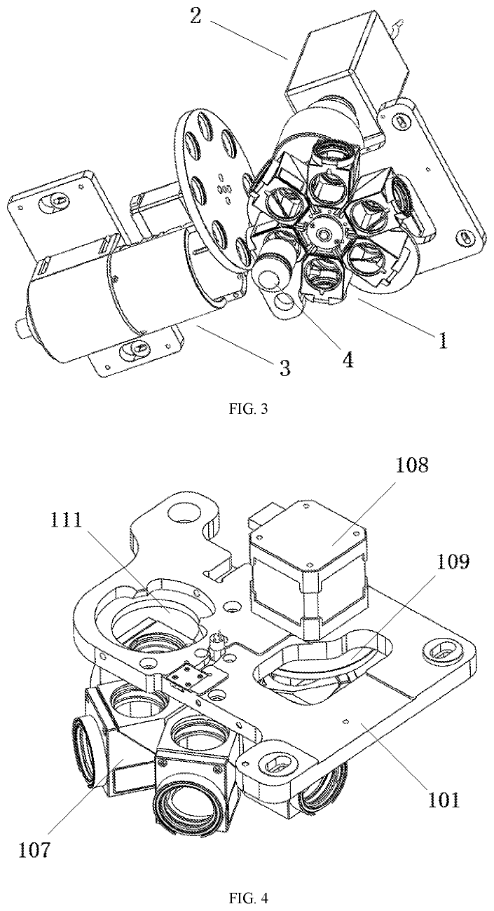

With reference to FIGS. 1-3, an electron microscope fluorescence assembly utilizing pulsed xenon lamp, comprising a wheel disc component 1, a camera component 2, and a light source component 3.

Preferably, with reference to FIGS. 4-7, the wheel disc component 1 comprises a horizontal wheel disc mounting plate 101, a lower surface of which is provided with a central shaft 102 extending vertically downward, a mounting shaft 104 driven by a wheel disc driving mechanism is rotatably sleeved on the central shaft 102 through two bearings 103; a locking nut 105 is provided at a bottom of the central shaft 102; a bearing cover plate 106 is sleeved on a periphery of the locking nut 105 and is fixedly connected to a lower end surface of the mounting shaft 104. The mounting shaft 104 is provided with multiple triple-hole fluorescence filter boxes 107 uniformly distributed around its circumference, for example, six triple-hole fluorescence filter boxes 107 is provided to form a six-hole wheel. A through hole 111 is provided on the wheel disc mounting plate 101, and a detection position is located directly below the through hole 111; the wheel disc driving mechanism drives the mounting shaft 104 to rotate at a fixed angle, thereby enabling all the triple-hole fluorescent filter boxes 107 to stay in the detection position in turn.

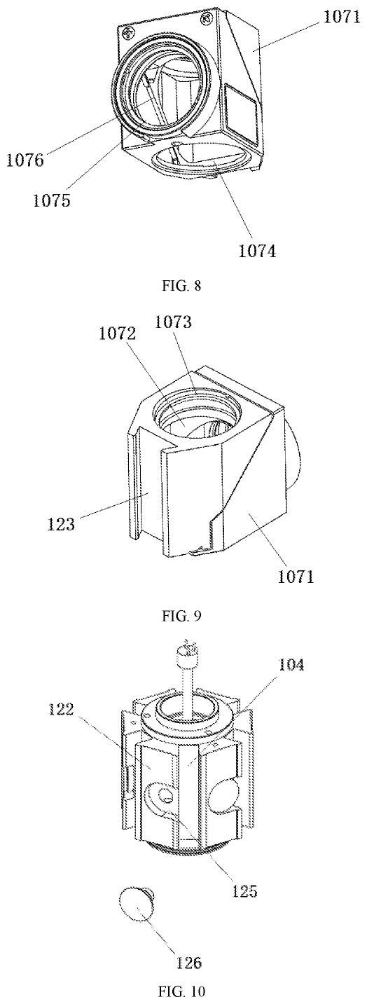

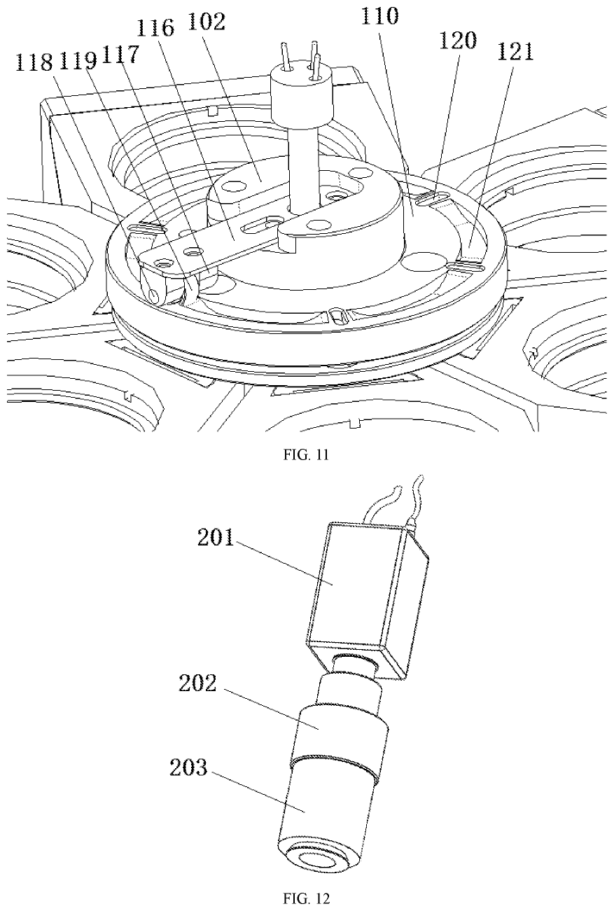

Preferably, with reference to FIGS. 8-9, the triple-hole fluorescent filter box 107 comprises a cubic box body 1071, and a top surface thereof is provided with an upper beam passage hole 1072 for docking with a lower end of the through hole 111, covered with a fluorescent filter 1073; a lower beam passage hole 1074 for docking with an upper end of the objective lens 4 is provided on a bottom surface of the cubic box body 1071, and the upper beam passage hole 1072 is concentric with the lower beam passage hole 1074; a side beam passage hole 1075 for docking with an inner end of the light source filter hole 314 is provided on one side surface of the cubic box body 1071; an inclined reflector 1076 is provided inside the cubic box body 1071, and the light source component 3 provides epi-illumination to the slide located below the objective lens 4 through the reflector 1076.

Preferably, with reference to FIGS. 4-5, the wheel disc driving mechanism is composed of a first stepper motor 108, a first spur gear 109, a second spur gear 110, and an angle sensor; the first stepper motor 108 is vertically mounted on the wheel disc mounting plate 101, and both are located on one side of the central shaft 102 and the camera component 2; the first spur gear 109 is fixedly mounted on an output shaft of the first stepper motor 108, and the second spur gear 110 is sleeved on a periphery of the central shaft 102 and fixedly connected to an upper end surface of the mounting shaft 104; the first spur gear 109 and the second spur gear 110 are at the same height position and mesh with each other.

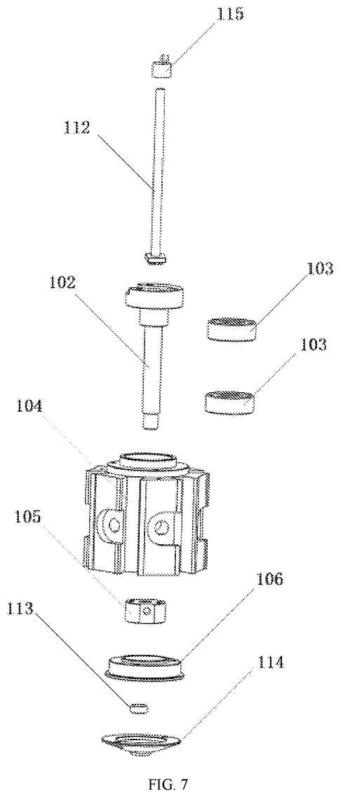

Preferably, with reference to FIG. 7, the angle sensor comprises a magnetic encoder 112, a central magnet 113, a magnet seat 114, and a socket 115; the magnetic encoder 112 is fixed on an axis of a lower end surface of the central shaft 102, and the magnet seat 114 is fixedly connected to a lower end surface of the mounting shaft 104; the central magnet 113 is fixed inside the magnet seat 114 and is located directly below the magnetic encoder 112; a cable of the magnetic encoder 112 passes upward through a hollow inner cavity of the central shaft 102 and is connected to the socket 115; the first stepper motor 108 measures the angular displacement of the angle sensor, thereby achieving a fixed angle rotation of the mounting shaft 104 and the alternating docking of all the triple-hole fluorescent filter boxes 107 with a lower end of the through hole.

Taking providing six of the triple-hole fluorescent filter boxes 107 as an example, the angular displacement of the first stepper motor 108 for one rotation is set to 60°; when the angle sensor measures that the angular displacement of the mounting shaft 104 reaches 60°, it is recorded as one rotation action of the first stepper motor 108, thereby realizing the fixed-angle rotation of the mounting shaft 104 in units of 60°, and further realizing the six triple-hole fluorescent filter boxes 107 staying in the detection position in turn.

Preferably, with reference to FIG. 7, in addition to the angle sensor with the magnetic encoder as the core, the invention also adopts a first mechanical angle-limiting mechanism. The first mechanical angle-limiting mechanism comprises a first flat spring 116, a first micro bearing seat 117, a first micro pin 118, a first roller 119, a plurality of first roller positioning counterbores 120 and a plurality of first roller rolling grooves 121 circumferentially provided on the second spur gear 110; an inner end of the first flat spring 116 is fixedly connected to an upper end surface of the central shaft 102, and an outer end of the first flat spring 116 points in a direction of the detection position; the first micro bearing seat 117 is fixed on a lower surface of the outer end of the first flat spring 116, and the first roller 119 is mounted on the first micro bearing seat 117 through the first micro pin 118; the number of the first roller positioning counterbores 120 and the first roller rolling grooves 121 corresponds to the number of the triple-hole fluorescent filter boxes 107, for example, both are 6, and the opening position of the first roller positioning counterbores 120 corresponds to the position of the triple-hole fluorescent filter boxes 107; the opening position of the first roller rolling groove 121 is located between two adjacent first roller positioning counterbores 120; an upper plane of the first roller positioning counterbores 120 is higher than an upper plane of the first roller rolling groove 121; the recessed first roller rolling groove 121 facilitates the rolling of the first roller 119, and the protruding first roller positioning counterbore 120 provides damping and a clamping point for the first roller 119.

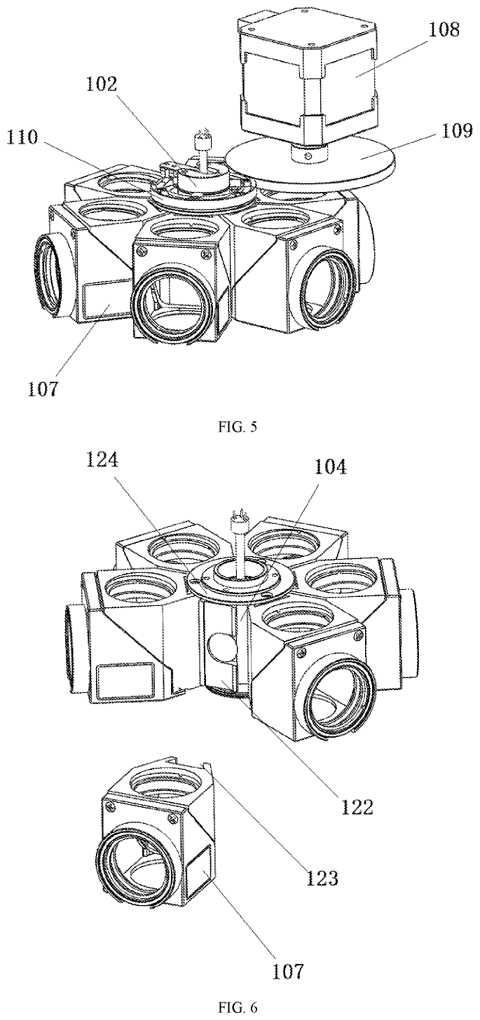

Preferably, with reference to FIGS. 6-10, each of the triple-hole fluorescence filter boxes 107 can be detachably mounted on a circumferential surface of the mounting shaft 104. The mounting shaft 104 is provided with vertical dovetail protrusions 122 uniformly distributed around its circumference, and the number of the dovetail protrusions 122 corresponds to the number of the triple-hole fluorescent filter boxes 107; a dovetail groove 123 capable of plugging and matching with the dovetail protrusion 122 is provided on one side surface of each triple-hole fluorescent filter box 107, and the position of the dovetail groove 123 is opposite to the position of the side beam passage hole 1075; a limiting plate 124 is provided on an outer periphery of an upper end of the mounting shaft 104, and the limiting plate 124 is fixedly connected to upper end surfaces of all the dovetail protrusions 122; the triple-hole fluorescent filter box 107 is quickly mounted with the mounting shaft 104 through the matching of the dovetail groove 123 and the dovetail protrusion 122, and positioning is achieved through the limiting plate 124. A C-shaped mounting groove 125 is provided on a surface of each dovetail protrusion 122; a notch of the C-shaped mounting groove 125 extends to a side edge of the dovetail protrusion 122, and an oblique pressure block 126 is provided in the C-shaped mounting groove 125 which can protrude outward or retract inward relative to an outer wall of the mounting shaft 104; an edge of the oblique pressure block 126 is located at the notch of the C-shaped mounting groove 125 and is flush with the edge of the dovetail protrusion 122, and the dovetail groove 123 is locked or unlocked with the dovetail protrusion 122 by the retraction or protrusion of the oblique pressure block 126.

Preferably, with reference to FIG. 12, the camera component 2 is located directly above the through hole 111. The camera component 2 is composed of a camera body 201, a reducing lens 202 and a lens barrel 203; a lower end of the lens barrel 203 is fixedly connected to a groove provided around an upper end of the through hole 111, and an upper end of the lens barrel 203 is connected to the lens of the camera body 201 through the reducing lens 202.

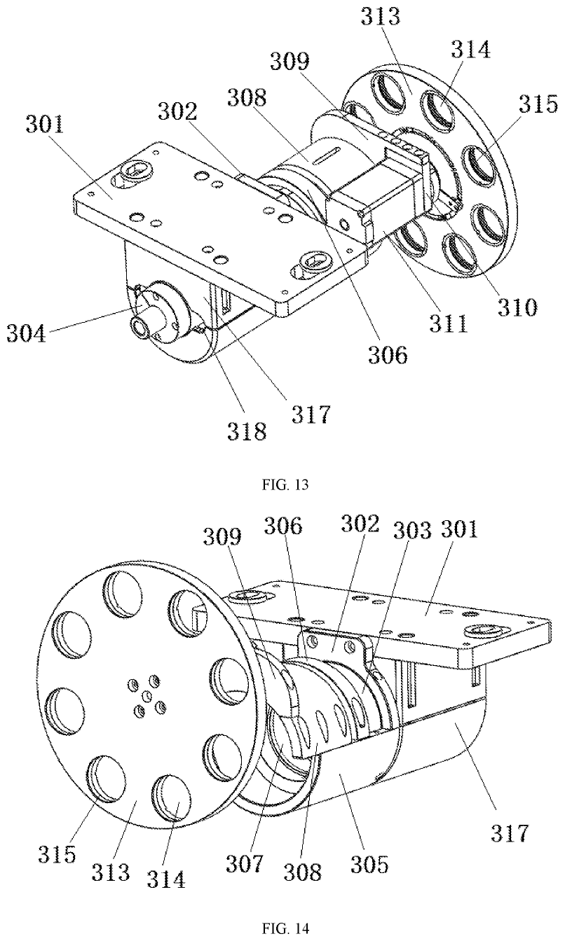

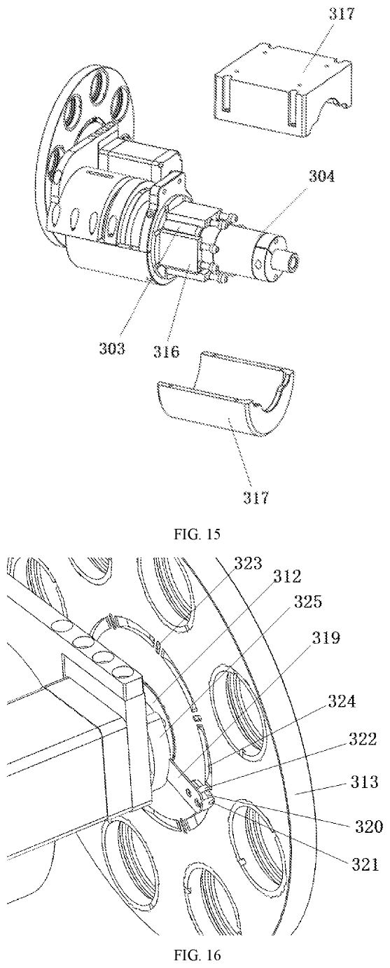

Preferably, with reference to FIGS. 13-16, the light source component 3 is located outside the detection position. The light source component 3 comprises a horizontal light source mounting plate 301 with a lamp holder seat 303 provided below through a lamp holder fixing seat 302, and the high-frequency pulsed xenon lamp 304 is fixedly mounted in the lamp holder seat 303; a C-shaped seat 305 extending forward is provided at a bottom end of the lamp holder fixing seat 302; the lens 307 is fixedly mounted on a middle part of the C-shaped seat 305 through a lens fixing piece 306. The lens 307 is located directly in front of the high-frequency pulsed xenon lamp 304, and the position directly in front of the lens 307 is a light-transmitting position. A side wheel disc connecting plate 308 is provided at a front part of the C-shaped seat 305; a connecting strip 309 extending to one side is provided on a top of the side wheel disc connecting plate 308, and the second stepper motor 311 is fixedly mounted on a lower surface of the connecting strip 309 through a motor mounting plate 310, and the second stepper motor 311 is also equipped with an angle sensor. An output shaft of the second stepper motor 311 is fixedly connected to a center of an outer side surface of the side wheel disk 313 through a connecting piece 312. The side wheel disc 313 is located in front of the lens 307 and is provided with multiple light source filter holes 314 uniformly distributed around its circumference, such as eight, each covered with a light source filter 315; the second stepper motor 311 drives the side wheel disk 313 to rotate at a fixed angle, thereby enabling all the light source filter holes 314 to stay in the light-transmitting position in turn.

Taking providing eight of the light source filter holes 314 as an example, the angular displacement of the second stepper motor 311 for one rotation is set to 45°; when the angle sensor of the second stepper motor 311 measures that the angular displacement of the side wheel disc 313 reaches 45°, it is recorded as one rotation action of the second stepper motor 311, thereby realizing the fixed-angle rotation of the side wheel disc 313 in units of 45°, and further realizing the eight light source filter holes 314 staying in the light-transmitting position in turn.

Preferably, with reference to FIG. 15, a plurality of water-cooling coolers 316 are fixedly attached to an outer surface of the lamp holder seat 303, and an outer cover of the lamp holder seat 303 is provided with a protective cover 317 for protecting the water-cooling coolers 316; an opening 318 is provided at a rear end of the protective cover 317, and a coolant circulation pipeline passes through the opening 318 and is connected to the water inlet and outlet of the water-cooling cooler 316.

Preferably, with reference to FIG. 16, the light source component 3 is provided with a second mechanical angle-limiting mechanism, which comprises a second flat spring 319, a second micro bearing seat 320, a second micro pin 321, a second roller 322, a plurality of second roller positioning counterbores 323 and a plurality of second roller rolling grooves 324 opened on a rear side surface of the side wheel disc 313 and arranged around the center of the circle; an inner end of the second flat spring 319 is fixedly connected to a front side surface of the motor mounting plate 310 through a flat spring fixing seat, and an outer end of the second flat spring 319 points in a direction away from the detection position; the second micro bearing seat 320 is fixedly arranged on a front side surface of an outer end of the second flat spring 319, and the second roller 322 is mounted on the second micro bearing seat 320 through the second micro pin 321. The number of the second roller positioning counterbores 323 and the second roller rolling grooves 324 corresponds to the number of the light source filter holes 314, for example, both are 8, and the opening position of the second roller positioning counterbores 323 correspond to the position of the light source filter holes 314; the opening position of the second roller rolling grooves 324 are located between two adjacent second roller positioning counterbores 323; an upper plane of the second roller positioning counterbores 323 is higher than an upper plane of the second roller rolling grooves 324; the recessed second roller rolling groove 324 facilitates the rolling of the second roller 322, and the protruding second roller positioning counterbore 323 provides damping and a clamping point for the second roller 322.

Preferably, the wheel disc mounting plate 101 is provided with an adjusting piece for adjusting the verticality of the camera component 2, the wheel disc component 1 and the objective lens 4, and the light source mounting plate 301 is provided with an adjusting piece for adjusting the distance between the light source component 3 and the wheel disc component 1. After correct mounting and adjustment, the camera component 2, the through hole 111, and the upper beam passage hole 1072 and the lower beam passage hole 1074 of the triple-hole fluorescent filter box 107 located at the detection position are vertically coaxial. The high-frequency pulsed xenon lamp 304, the lens 307, the light source filter hole 314 located at the light-transmission position, and the side beam passage hole 1075 of the triple-hole fluorescent filter box 107 located at the detection position are horizontally coaxial.

Preferably, the high-frequency pulsed xenon lamp 304 is a light source designed and manufactured using the principle of high-voltage ionized xenon light emission. The high-frequency pulsed xenon lamp 304 is made by encapsulating high-voltage (pressure is about 1/10 or less than that of a continuous xenon lamp) xenon gas in a transparent lampshade, and then inputting a high-frequency pulse voltage signal to both ends of the metal electrode, so that the xenon gas between the electrodes in the tube is ionized and emits light. The high-frequency pulsed xenon lamp 304 of the invention can provide high-frequency pulsed light of 160-7500 nm, and the frequency can reach 200 Hz. The frequency of the light source used in the prior art is mostly 10 Hz. The frequency of the high-frequency pulsed xenon lamp 304 of the invention is 20 times that of the prior art, which can be called high frequency in comparison. The single luminous energy of the high-frequency pulsed xenon lamp 304 can reach 3 joules, and the continuous luminous time is 5 μs. If converted into continuous light, its power can reach 6×105 W. The high-frequency pulsed xenon lamp 304 has the characteristics of high luminous intensity, short warm-up time, and good stability, and is very suitable for high-speed fluorescence microscopy.

With reference to FIG. 17, the working principle of the invention is as follows.

First, the second stepper motor 311 drives the side wheel disc 313 to rotate a certain angle, and rotates the light source filter hole 314 with the required light source filter 315 to the light-transmitting position. After it is in place, the second roller positioning counterbore 323 corresponding to the position of the light source filter hole 314 contacts the second roller 322 as the side wheel disc 313 rotates, and at the same time, the second roller positioning counterbore 323 lifts the second roller 322, and the second flat spring 319 immediately changes from a straight state to an upward state, so that the second roller 322 is clamped with the second roller positioning counterbore 323, thereby realizing the mechanical positioning of the light source filter hole 314.

Then, the first stepper motor 108 drives the mounting shaft 104 to rotate a certain angle, and the required triple-hole fluorescent filter box 107 is rotated to the detection position. After it is in place, the first roller positioning counterbore 120 corresponding to the position of the triple-hole fluorescent filter box 107 contacts the first roller 119 as the mounting shaft 104 rotates, and at the same time, the first roller positioning counterbore 120 lifts the first roller 119, and the first flat spring 116 immediately changes from a straight state to an upward state, so that the first roller 119 is clamped with the first roller positioning counterbore 120, thereby realizing the mechanical positioning of the triple-hole fluorescent filter box 107.

Finally, turn on the high-frequency pulsed xenon lamp 304 and the camera body 201. The high-frequency pulsed xenon lamp 304 provides high-frequency pulsed light of 160-7500 nm, and the single continuous light emission time is 5 μs. The light beam emitted by the high-frequency pulsed xenon lamp 304 passes through the lens 307 and the light source filter 315 and enters the triple-hole fluorescent filter box 107, and then is reflected by the reflector 1076 and emitted downward through the objective lens 4 to the slide, illuminating the sample on the slide, and then the light beam is reflected by the sample and emitted upward through the objective lens 4, the reflector 1076, and the fluorescent filter 1073 to the camera body 201, thereby realizing epi-illumination for the high-speed fluorescence microscope.

The pulsed xenon lamp technology proposed in the invention can provide a microsecond-level high-brightness light source without the need for preheating. It can greatly increase the shooting rate (200 frames per second) without reducing the image quality, which is more than 20 times that of the existing technology.

The above embodiments merely represent preferred implementations of the invention and are not intended to limit the scope of the invention. Those skilled in the art may make various modifications and variations to the invention. Any amendment, equivalent substitution, or improvement made within the spirit and principles of the invention shall be included within the protection scope of the invention.

1. (canceled)

2. A fluorescence microscope fluorescence assembly utilizing pulsed xenon lamp, comprising a wheel disc component, a camera component, and a light source component, wherein:
the wheel disc component comprises a horizontal wheel disc mounting plate, a lower surface of which is provided with a central shaft extending vertically downward, a mounting shaft driven by a wheel disc driving mechanism is rotatably sleeved on the central shaft, and the mounting shaft is provided with multiple triple-hole fluorescence filter boxes uniformly distributed around its circumference; a through hole is provided on the wheel disc mounting plate, and a detection position is located directly below the through hole; the wheel disc driving mechanism drives the mounting shaft to rotate at a fixed angle, thereby enabling all the triple-hole fluorescent filter boxes to stay in the detection position in turn; the camera component is located directly above the through hole, and the camera component, the through hole and the triple-hole fluorescent filter box located at the detection position are vertically coaxial; the light source component is located outside the detection position, and comprises a high-frequency pulsed xenon lamp, a lens, and a side wheel disc driven by a second stepper motor; the lens is located directly in front of the high-frequency pulsed xenon lamp, and the position directly in front of the lens is a light-transmitting position; the side wheel disc is located in front of the lens and is provided with multiple light source filter holes uniformly distributed around its circumference, each covered with a light source filter; the second stepper motor drives the side wheel disk to rotate at a fixed angle, thereby enabling all the light source filter holes to stay in the light-transmitting position in turn; the high-frequency pulsed xenon lamp, the lens, the light source filter hole located at the light-transmitting position, and the triple-hole fluorescent filter box located at the detection position are transversely coaxial;
the wheel disc driving mechanism is composed of a first stepper motor, a first spur gear, a second spur gear, and an angle sensor; the first stepper motor is vertically mounted on the wheel disc mounting plate, and both are located on one side of the central shaft and the camera component; the first spur gear is fixedly mounted on an output shaft of the first stepper motor, and the second spur gear is sleeved on a periphery of the central shaft and fixedly connected to an upper end surface of the mounting shaft; the first spur gear and the second spur gear are at the same height position and mesh with each other; the angle sensor comprises a magnetic encoder, a central magnet, a magnet seat, and a socket; the magnetic encoder is fixed on an axis of a lower end surface of the central shaft, and the magnet seat is fixedly connected to a lower end surface of the mounting shaft; the central magnet is fixed inside the magnet seat and is located directly below the magnetic encoder; a cable of the magnetic encoder passes upward through a hollow inner cavity of the central shaft and is connected to the socket; the first stepper motor measures the angular displacement of the angle sensor, thereby achieving a fixed angle rotation of the mounting shaft and the alternating docking of all the triple-hole fluorescent filter boxes with a lower end of the through hole;
the wheel disc component is provided with a first mechanical angle-limiting mechanism, which comprises a first flat spring, a first micro bearing seat, a first micro pin, a first roller, a plurality of first roller positioning counterbores and a plurality of first roller rolling grooves circumferentially provided on the second spur gear; an inner end of the first flat spring is fixedly connected to an upper end surface of the central shaft, and an outer end of the first flat spring points in a direction of the detection position; the first micro bearing seat is fixed on a lower surface of the outer end of the first flat spring, and the first roller is mounted on the first micro bearing seat through the first micro pin; the number of the first roller positioning counterbores and the first roller rolling grooves corresponds to the number of the triple-hole fluorescent filter boxes, and the opening position of the first roller positioning counterbores corresponds to the position of the triple-hole fluorescent filter boxes; the opening position of the first roller rolling groove is located between two adjacent first roller positioning counterbores; an upper plane of the first roller positioning counterbores is higher than an upper plane of the first roller rolling groove to provide damping and a clamping point for the first roller;
the light source component is provided with a second mechanical angle-limiting mechanism, which comprises a second flat spring, a second micro bearing seat, a second micro pin, a second roller, a plurality of second roller positioning counterbores and a plurality of second roller rolling grooves opened on a rear side surface of the side wheel disc and arranged around the center of the circle; an inner end of the second flat spring is fixedly connected to a front side surface of the motor mounting plate through a flat spring fixing seat, and an outer end of the second flat spring points in a direction away from the detection position; the second micro bearing seat is fixedly arranged on a front side surface of an outer end of the second flat spring, and the second roller is mounted on the second micro bearing seat through the second micro pin; the number of the second roller positioning counterbores and the second roller rolling grooves corresponds to the number of the light source filter holes, and the opening position of the second roller positioning counterbores correspond to the position of the light source filter holes; the opening position of the second roller rolling grooves are located between two adjacent second roller positioning counterbores; an upper plane of the second roller positioning counterbores is higher than an upper plane of the second roller rolling grooves to provide damping and a clamping point for the second roller.

3. (canceled)

4. (canceled)

5. The fluorescence microscope fluorescence assembly utilizing pulsed xenon lamp of claim 1, wherein the triple-hole fluorescent filter box comprises a cubic box body, and a top surface thereof is provided with an upper beam passage hole for docking with a lower end of the through hole, covered with a fluorescent filter; a lower beam passage hole for docking with an upper end of the objective lens is provided on a bottom surface of the cubic box body, and the upper beam passage hole is concentric with the lower beam passage hole; a side beam passage hole for docking with an inner end of the light source filter hole is provided on one side surface of the cubic box body; an inclined reflector is provided inside the cubic box body, and the light source component provides epi-illumination to the slide located below the objective lens through the reflector.

6. The fluorescence microscope fluorescence assembly utilizing pulsed xenon lamp of claim 2, wherein the mounting shaft is provided with vertical dovetail protrusions uniformly distributed around its circumference, and the number of the dovetail protrusions corresponds to the number of the triple-hole fluorescent filter boxes; a dovetail groove capable of plugging and matching with the dovetail protrusion is provided on one side surface of each triple-hole fluorescent filter box, and the position of the dovetail groove is opposite to the position of the side beam passage hole; a limiting plate is provided on an outer periphery of an upper end of the mounting shaft, and the limiting plate is fixedly connected to upper end surfaces of all the dovetail protrusions; the triple-hole fluorescent filter box is quickly mounted with the mounting shaft through the matching of the dovetail groove and the dovetail protrusion, and positioning is achieved through the limiting plate; a C-shaped mounting groove is provided on a surface of each dovetail protrusion; a notch of the C-shaped mounting groove extends to a side edge of the dovetail protrusion, and an oblique pressure block is provided in the C-shaped mounting groove which can protrude outward or retract inward relative to an outer wall of the mounting shaft; an edge of the oblique pressure block is located at the notch of the C-shaped mounting groove and is flush with the edge of the dovetail protrusion, and the dovetail groove is locked or unlocked with the dovetail protrusion by the retraction or protrusion of the oblique pressure block.

7. The fluorescence microscope fluorescence assembly utilizing pulsed xenon lamp of claim 1, wherein the light source component comprises a horizontal light source mounting plate with a lamp holder seat provided below through a lamp holder fixing seat, and the high-frequency pulsed xenon lamp is fixedly mounted in the lamp holder seat; a C-shaped seat extending forward is provided at a bottom end of the lamp holder fixing seat; the lens is fixedly mounted on a middle part of the C-shaped seat through a lens fixing piece, and a side wheel disc connecting plate is provided at a front part of the C-shaped seat; a connecting strip extending to one side is provided on a top of the side wheel disc connecting plate, and the second stepper motor is fixedly mounted on a lower surface of the connecting strip through a motor mounting plate; a center of an outer side surface of the side wheel disc is fixedly connected to an output shaft of the second stepper motor through a connecting piece.

8. The fluorescence microscope fluorescence assembly utilizing pulsed xenon lamp of claim 4, wherein a plurality of water-cooling coolers are fixedly attached to an outer surface of the lamp holder seat, and an outer cover of the lamp holder seat is provided with a protective cover for protecting the water-cooling coolers; a rear end of the protective cover is provided with an opening for the cooling liquid circulation pipeline to pass through.

9. (canceled)

10. The fluorescence microscope fluorescence assembly utilizing pulsed xenon lamp of claim 1, wherein the high-frequency pulsed xenon lamp emits pulsed light at 160-7500 nm wavelengths with a maximum frequency of 200 Hz.

11. A fluorescence microscope illumination method utilizing pulsed xenon lamp, wherein a high-frequency pulsed xenon lamp is used as a light source to provide high-frequency pulsed illumination through epi-illumination to a sample on a slide, including the following steps:
step 1) generating lateral pulsed light beams using the high-frequency pulsed xenon lamp;
step 2) filtering the pulsed light beams through a light source filter;
step 3) reflecting the filtered pulsed light beams downward via a reflector;
step 4) directing the downward-reflected pulsed light beams onto the slide through an objective lens, wherein a part of the pulsed light beams is reflected upward upon contacting the sample;
step 5) directing the upward-reflected pulsed light beams sequentially through the objective lens, the reflector, and a fluorescence filter before entering a camera.
